(19) United States
(12) Patent Application Publication
(10) Pub. No.: US 2004/0052332 A1
(43) Pub. Date: Mar. 18, 2004

(54) X-ray collimator and a method of making an x-ray collimator

(76) Inventors: Andrew J. Banchieri, Newark, CA (US); David E. Kresse, Walnut Creek, CA (US)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/244,130

(22) Filed: Sep. 13, 2002

(51) Int. Cl. G21K 1/02

(52) U.S. Cl. 378/147

(57) ABSTRACT

A method is described for making an x-ray collimator. A plurality of collimator sheets are formed. Each collimator sheet has a plurality of septa lands that are made of a material that substantially attenuates x-ray radiation. A respective region is defined between a respective pair of the septa lands which is free of the material. The collimator sheets are positioned adjacent to one another. Adjacent corresponding lands of the collimator sheets are positioned adjacent to one another.

### STATEMENT REGARDING FEDERALLY SPONSORED RESEARCH OR DEVELOPMENT

Certain aspects of this invention were developed with support from the FAA (Federal Aviation Association). The U.S. Government may have rights in certain of these inventions.

### BACKGROUND OF THE INVENTION

1). Field of the Invention

This invention relates to an x-ray collimator and a method of making an x-ray collimator.

2). Discussion of Related Art

X-ray technique-based nonintrusive inspection apparatus are often used for airport bag scanning for purposes of detecting contraband or explosives, or for medical imaging and diagnosis. Such a system usually has an x-ray source that radiates x-rays through a closed container or the body of a person, and a number of x-ray detector crystals that are used for detecting the intensity of the x-rays after passing through the container or the body of the person.

X-rays tend to scatter when passing through the container or the body of the person and from walls within the system, so that x-rays that emit toward a particular crystal may come from various different directions. X-ray collimators are usually mounted over the x-ray detector crystals. A collimator usually has a number of septa made of a material such as lead that substantially attenuates x-ray radiation. The septa are aligned with the x-ray source and collimate the x-rays so that x-rays detected by the x-ray detector crystals are primarily those x-rays being emitted directly from the x-ray source through the container or the body of the person.

The x-ray source is usually at a single location, and the x-ray detector crystals are spread out over a wider area. Each collimator preferably has septa with center lines that are aligned with the x-ray source in order to accurately collimate x-rays that are detected by all of the x-ray detector crystals. The manufacture of such a collimator is relatively cumbersome, and usually involves a complicated machining operation. The collimators may alternatively be formed in a cast, but such a cast may be intricate and expensive to manufacture, and it may be difficult to remove the collimators from the cast.

### SUMMARY OF THE INVENTION

This invention relates to a method of making an x-ray collimator. A plurality of collimator sheets are formed. Each collimator sheet has a plurality of septa lands that are made of a material that substantially attenuates x-ray radiation. A respective region is defined between a respective pair of the septa lands which is free of the material. The collimator sheets are positioned adjacent to one another. Adjacent corresponding lands of the collimator sheets are positioned adjacent to one another.

Center lines of septa pieces defined by the septa lands preferably converge toward one another.

Center lines of x-ray passages formed by the regions preferably converge toward one another.

The material is preferably molybdenum.

The regions are preferably septa openings in the respective collimator sheet.

A mask may be formed on each collimator sheet, the mask having a plurality of mask openings formed therein. The collimator sheet may then be etched with the mask preventing etching of the septa lands while allowing etching of the septa openings through the mask openings.

The invention also provides an x-ray collimator. The x-ray collimator comprises a plurality of collimator sheets. Each collimator sheet has a plurality of septa lands made of a material that substantially attenuates x-ray radiation. A respective region is defined between a respective pair of the septa lands which is free of the material. The collimator sheets are positioned adjacent to one another so that adjacent corresponding septa lands of the collimator sheets are positioned adjacent to one another.

### BRIEF DESCRIPTION OF THE DRAWINGS

The invention is further described by way of example with reference to the accompanying drawings, wherein:

FIG. 1 is a top plan view of a collimator sheet having upper and lower masks formed thereon;

FIG. 2 is a cross-sectional side view of the collimator sheet and masks of FIG. 1;

FIG. 3 is a view similar to FIG. 1 after the collimator sheet is etched with the mask preventing etching of portions of the collimator sheet;

FIG. 4 is a cross-sectional side view of the collimator sheet and masks of FIG. 3;

FIG. 5 is a view similar to FIG. 3 after the masks have been removed;

FIG. 6 is a cross-sectional side view of x-ray detector crystals and an x-ray collimator on the x-ray detector crystals, the x-ray collimator having been made by stacking a plurality of collimator sheets on top of one another, according to an embodiment of the invention; and

FIG. 7 is an end view of a gantry assembly that includes a plurality of collimators such as in FIG. 6.

### DETAILED DESCRIPTION OF THE INVENTION

FIGS. 1 through 6 illustrate a method of making an x-ray collimator. A plurality of collimator sheets are stacked on one another. Each sheet is etched to have a number of septa openings defined between respective septa lands. The septa lands of the sheets jointly form septa pieces having center lines that converge toward one another, so that extensions of the center lines meet at an x-ray source.

Referring first to FIGS. 1 and 2, one collimator sheet 20 is shown that is covered with upper and lower masks 22. Each mask 22 has a plurality of elongated mask openings 24 formed therein. The mask openings 24 are formed adjacent to one another with a respective mask land 26 between a respective pair of the mask openings 24. The mask openings 24 of the upper and lower masks 22 are aligned with one another. The collimator sheet 20 is exposed in the openings 24.

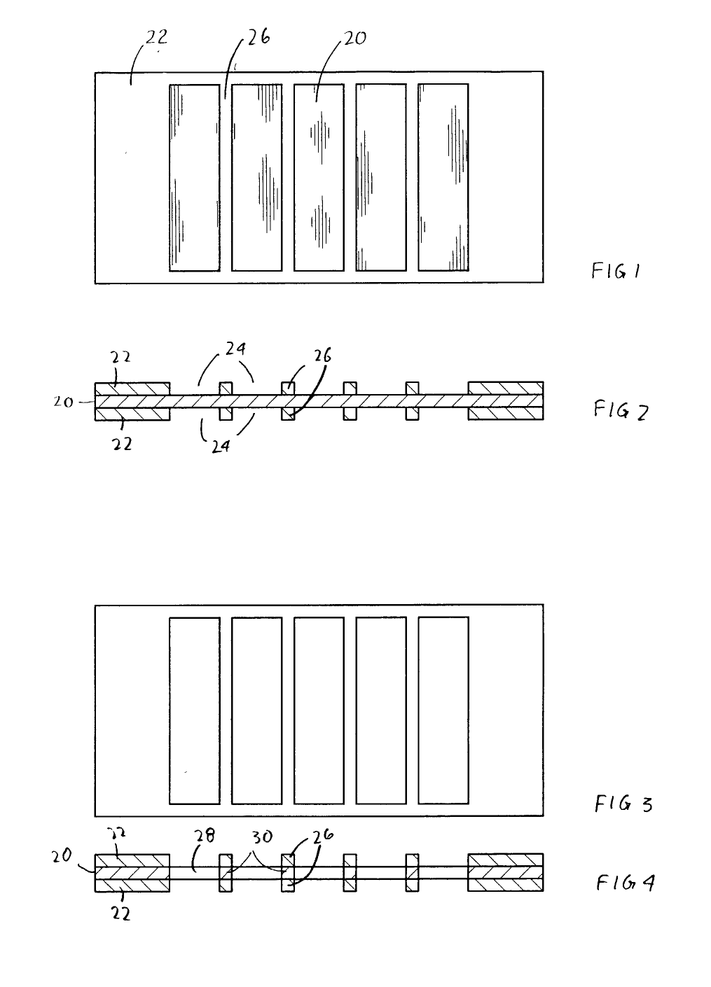

As illustrated in FIGS. 3 and 4, the collimator sheet 20 is subsequently etched. The masks 22 prevent etching of portions of the collimator sheet 20 between the masks 22. A respective septa opening 28 is etched where the mask openings 24 are. The septa openings 28 are separated from one another by septa lands 30 that are sandwiched between the mask lands 26. As illustrated in FIG. 5, the masks (22 in FIGS. 1, 2, and 4) are subsequently removed to expose the collimator sheet 20.

The collimator sheet 20 is made of molybdenum Other materials that may be used because of their ability to substantially attenuate x-ray radiation generally have atomic numbers above 23, such as tantalum, titanium, tungsten, tin, ruthenium, lead, and iron. For the present high-energy x-ray application, the material should preferably have an atomic number of at least 35. Some materials, such as molybdenum and ruthenium, may be easier to etch than other materials such as lead. Lead by itself may also lack the mechanical strength to be rotated at high speed, and may have to be alloyed with a material such as tin.

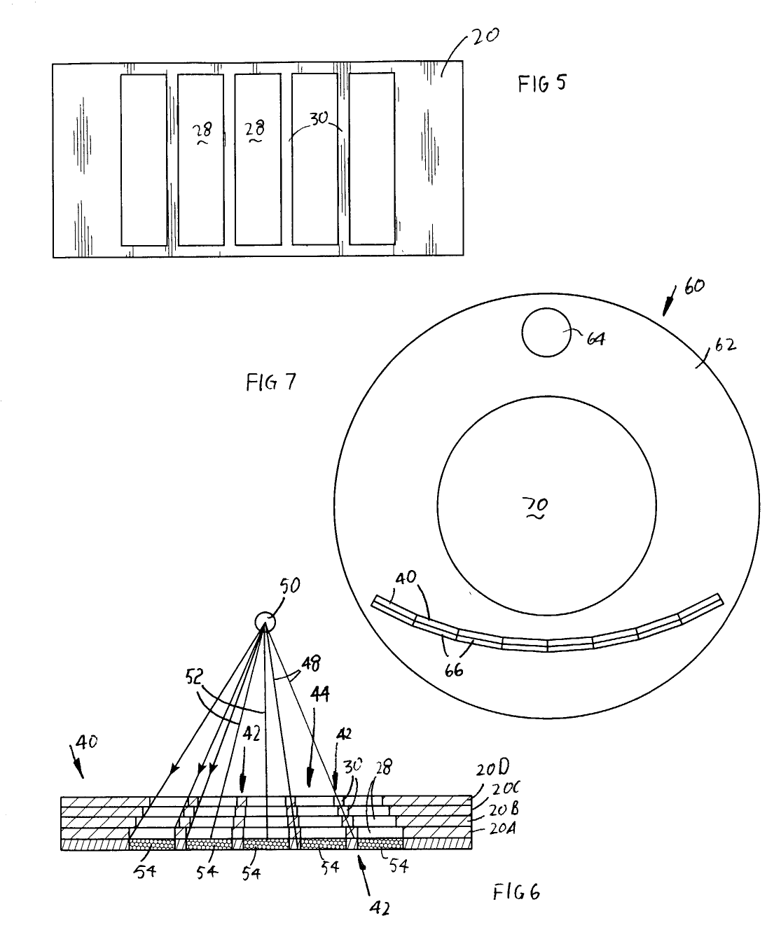

FIG. 6 illustrates an x-ray collimator 40 that is made by stacking a plurality of collimator sheets 20A-D on top of one another. Each one of the sheets 20A to 20D is manufactured according to the method illustrated in FIGS. 1, 2, and 5. Adjacent septa lands 30 of adjacent ones of the collimator sheets 20A-D jointly form a respective septa piece 42. The septa openings 28 that are located over one another jointly form respective x-ray passages 44. Center lines 48 of the septa pieces 42 converge to a single point 50. Similarly, center lines 52 of the x-ray passages 44 converge to the same point 50. X-rays from an x-ray source located at the point 50 can be collimated by the septa pieces 42 toward individual x-ray crystals 54 below respective ones of the x-ray passages 44.

It can thus be seen that a relatively uncomplicated and inexpensive method is provided for forming an x-ray collimator. Differing collimators can be made by simply modifying the masks 22.

FIG. 7 illustrates a gantry assembly 60, including a gantry 62, an x-ray source 64, a plurality of x-ray collimators 40, and a plurality of blocks 66 of x-ray detector crystals. The gantry 62 has a gantry opening 70 through which a container can be transferred. The x-ray source 64 is secured to the gantry 62 above the gantry opening 70, and the x-ray collimators 40 and blocks 66 are secured to the gantry 62 below the gantry opening 70. Referring jointly to FIGS. 6 and 7, each one of the x-ray collimators 40 has a plurality of septa pieces 42 and x-ray passages 44, with center lines 48 and 52 that converge toward the x-ray source 63.

In use, a closed container is transferred on a conveyor belt through the gantry opening 70. X-rays are emitted by the x-ray source 64 and transmit through the container toward the x-ray collimator s 40. The x-rays are detected by the x-ray detector crystals of the blocks 66. The gantry 62 may be rotatably mounted to a support frame. Rotation of the gantry 62 will result in CT-type scanning by radiating through the container from different sides.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of making an x-ray collimator, comprising:
forming a plurality of collimator sheets, each collimator sheet having a plurality of septa lands made of a material that substantially attenuates x-ray radiation, a respective region being defined between a respective pair of the septa lands which is free of the material; and
positioning the collimator sheets adjacent to one another so that adjacent corresponding septa lands of the collimator sheets are positioned adjacent to one another.

2. The method of claim 1, wherein the material is molybdenum

3. The method of claim 1, wherein the regions are septa openings in the respective collimator sheet.

4. The method of claim 3, further comprising:
forming a mask on each collimator sheet, the mask having a plurality of mask openings formed therein; and
etching the collimator sheet with the mask preventing etching of the septa lands while allowing etching of the septa openings through the mask openings.

5. The method of claim 1, wherein center lines of septa pieces defined by the septa lands converge toward one another.

6. The method of claim 1, wherein center lines of x-ray passages formed by the regions converge toward one another.

7. A method of making an x-ray collimator, comprising:
forming a plurality of collimator sheets, each collimator sheet having a plurality of septa lands made of a material that substantially attenuates x-ray radiation, a respective region being defined between a respective pair of the septa lands which is free of the material; and
positioning the collimator sheets adjacent to one another so that adjacent corresponding septa lands of the collimator sheets are positioned adjacent to one another, wherein center lines of septa pieces defined by the septa lands converge toward one another and center lines of x-ray passages formed by the regions converge toward one another.

8. A method of making an x-ray collimator, comprising:
forming a respective mask on each of a plurality of collimator sheets, the mask having a plurality of mask openings formed therein;
etching the collimator sheet with the mask preventing etching of septa lands of the collimator sheet while allowing for etching of a respective septa opening through each mask opening between a respective pair of the septa lands; and
positioning the collimator sheets adjacent to one another so that adjacent corresponding septa lands of the collimator sheets jointly are positioned adjacent to one another.

9. The method of claim 8, wherein center lines of septa pieces defined by the septa lands converge toward one another.

10. The method of claim 9, wherein center lines of x-ray passages formed by the regions converge toward one another.

11. An x-ray collimator comprising a plurality of collimator sheets, each collimator sheet having a plurality of septa lands made of a material that substantially attenuates x-ray radiation, a respective region being defined between a respective pair of the septa lands which is free of the material, the collimator sheets being positioned adjacent to one another so that adjacent corresponding septa lands of the collimator sheets are positioned adjacent to one another.

12. The x-ray collimator of claim 11, wherein the material is molybdenum

13. The x-ray collimator of claim 11, wherein the regions are septa openings in the respective collimator sheet.

14. The x-ray collimator of claim 11, wherein center lines of septa pieces defined by the septa lands converge toward one another.

15. The x-ray collimator of claim 11, wherein center lines of x-ray passages formed by the regions converge toward one another.

16. The x-ray collimator of claim 11, wherein center lines of septa pieces defined by the septa lands converge toward one another and center lines of x-ray passages formed by the regions converge toward one another.

17. An x-ray collimator comprising a plurality of collimator sheets, each collimator sheet having a plurality of septa lands made of molybdenum, a respective opening being defined between a respective pair of the septa lands which is free of the molybdenum, the collimator sheets being positioned adjacent to one another so that adjacent corresponding septa lands of the collimator sheets are positioned adjacent to one another, wherein center lines of septa pieces defined by the septa lands converge toward one another and center lines of x-ray passages formed by the openings converge toward one another.
